(19) United States
(12) Patent Application Publication
(10) Pub. No.: US 2015/0210839 A1
(43) Pub. Date: Jul. 30, 2015

(54) NEW COMPOSITE MATERIALS BASED ON RUBBERS, ELASTOMERS, AND THEIR RECYCLED

(71) Applicants: KAUTEC TECHNOLOGIES, S.A.P.I. DE C.V., Chihuahua (MX); Centro de Investigación en Materiales Avanzados, S.C, Chihuahua (MX)

(72) Inventors: René LOYA ENRÍQUEZ, Chihuahua (MX); Grecia Andrea BUENO HERRERA, Chihuahua (MX); Sergio Gabriel FLORES GALLARDO, Chihuahua (MX); Erasto Armando ZARAGOZA CONTRERAS, Chihuahua (MX); Alejandro VEGA RÍOS, Chihuahua (MX); Mónica Elvira MENDOZA DUARTE, Chihuahua (MX); Erika Ivonne LÓPEZ MARTÍNEZ, Chihuahua (MX)

(21) Appl. No.: 14/608,327

(22) Filed: Jan. 29, 2015

(30) Foreign Application Priority Data
Jan. 30, 2014 (MX) MX/A/2014/001230

(51) Int. Cl. C08L 21/00; C08L 9/06; C08L 67/00; C08L 23/22; C08L 75/04; C08L 9/02; C08L 9/00

(52) U.S. Cl. CPC C08L 21/00; C08L 9/02; C08L 9/06; C08L 9/00; C08L 23/22; C08L 75/04; C08L 67/00; C08L 2205/02; C08L 2205/03; C08L 2205/035; C08L 2207/20

(57) ABSTRACT

The present invention refers to developing and obtaining new composite materials based on rubbers and/or elastomers and/or their recycled can be reused through an in situ polymerization program between the combination of different monomers and/or oligomers type diisocyanate, esters, or organic peroxides cross-linking agent, which in their combination generate a binding agent capable of modifying the intrinsic chemical, thermal, rheological, and mechanical properties of each base material, due to the chemical curing of the monomers present in the material and the chains chemical cross-linking originated by the incorporation of organic peroxides which are able to accelerate or decrease the reaction rate.

### OBJECT OF THE INVENTION

The present invention refers to developing and obtaining new composite materials based on rubbers, and/or elastomers and/or their recycled can be reused through an in situ polymerization program between the combination of different monomers and/or diisocyanate oligomers, esters, or organic peroxides cross-linking agent, which in their combination generate a binding agent capable of modifying the intrinsic chemical, thermal, rheological, and mechanical properties of each base material, due to the chemical curing of the monomers present in the material and the chemical chain cross-linking originated by the incorporation of organic peroxides which are able to accelerate or decrease the reaction rate.

All of the materials were prepared based on a rubber, and/or elastomers, and/or its recycled from waste materials, which are grinded and sifted on different types of mesh numbers, in order to obtain a homogeneous particle size, whose particle size may be between 1 mm and 10 mm. For the production of each one of the binders, calculations were performed on the corresponding quantities in equivalent, departing from a known value in diol grams (corresponding between 5-90% of the recycled elastomer) and determining the amount of isocyanate required for achieving desired ratio of NCO/OH=2. Subsequently, considering the free NCO equivalents in the prepolymer, was added the required amount of the chain extender required so that in the final material did not contain free NCO. Different materials were generated replacing the chain extenders with organic peroxides and combining the chain extenders in equivalent amounts in % by weight with organic peroxides. The organic peroxides considered by the present invention are dicumyl peroxide, Lauryl peroxide, and benzoyl peroxide.

This invention is related with substantial improvement, derived from the use of chain extenders, organic peroxides, and their equivalent combinations to generate new chemical structures through an in situ polymerization system between the combination of different monomers and/or diisocyanate oligomers, and/or esters, which in their combination generate binding agents capable of modifying the intrinsic chemical, thermal, rheological, and mechanics properties of each composite material based on rubbers, elastomers, and/or its recycled. Which allows the composition to be transformed through a molding process by compression, rotational molding, extrusion, and injection, transforming it into various products of industrial utility.

### DETAILED DESCRIPTION OF THE INVENTION

The present invention includes the details of the types of materials used and the procedure to develop and obtain new compounds based on rubber, elastomers, and/or it's recycled.

The type of materials that are used in the present invention:

### Rubbers

The term rubber refers to a natural or synthetic polymer.

The natural rubber is a polymer characterized by its long and thread-like molecules, which is obtained from a secretion (natural latex) that emerges from the trunk of some plant species, is mainly composed of isoprene molecules, which form a high molecular weight polymer.

The synthetic or elastomer rubber is commercially produced from hydrocarbons, by polymerizing of mono-olefins as the isobutylene and diolefins, such as butadiene and isoprene. The elastomers can also be obtained by the copolymerization of olefins with diolefins, such as in the case of styrene-butadiene (SBR). Another possibility is the copolymerization of two different olefins such as ethylene-propylene, which have the characteristic properties of the elastomers.

Many of the principal synthetic rubbers are based on the butylenes. Butadiene is part of almost all of the formulas as shown in the following table:

| Name | Monomers | Typical Composition |
|---|---|---|
| Polybutadiene | Butadiene | 75% Butadiene + 25% |
| | | styrene |
| GRS, Buna S, SBR | Butadiene + | 15% Butadiene + 85% |
| | Styrene | styrene |
| GRN, Buna N, NBR | Butadiene + | 60-80% Butadiene + |
| | acrylonitrile | 40-20% acrylonitrile |
| Neoprene CR | Chloroprene + | 97-98% isobutylenes + |
| GRI, Butyl, IIR | Isobutylene + | 3-2% isoprene |
| | isoprene | |

### Rubber Types

### Polybutadiene (BR)

Polybutadiene is an elastomer or synthetic rubber that is obtained through the polymerization of 1,3-butadiene. The butadiene molecule may be polymerized in three different ways, forming three isomers called cis-1, 4 polybutadiene, trans-1,4-polybutadiene, and vinyl (1,2-polybutadiene). The present invention may use the following polybutadiene rubbers based on the classification of the numbering system IISRP (International Institute of Synthetic Rubber Producers):

| POLYBUTADIENE | SERIES (IISRP) |
|---|---|
| Oil-Free Rubber/without pigment | 1200-1249 |
| Rubber with oil | 1250-1299 |
| Rubber with black smoke | 1300-1349 |
| Rubber with oil and black smoke | 1350-1399 |
| Latex | 1400-1449 |

### Butadiene Styrene Rubber (SBR)

Butadiene styrene rubber is derived from two monomers, styrene and butadiene. The mixture of these two monomers are polymerized by two different processes: basically a solution or as an emulsion. Both are employed for the formation of new materials, the E-SBR type produced by the polymerization in emulsion that is initiated by free radicals. And the SBR-solution type, which is produced by an anionic polymerization process. For the present invention, the following SBR rubbers based on the classification of the system of numbering IISRP (International Institute of Synthetic Rubber Producers) may be used:

| SBR | (IISRP) SERIES |
|---|---|
| Hot polymerized Rubbers, not Pigmented | 1000 |
| Cold polymerized Rubbers, not Pigmented | 1500 |
| With black smoke and less than 14 phr of oil | 1600 |
| With oil | 1700 |
| With black smoke and more than 14 phr of oil | 1800 |

### Butadiene-Acrylonitrile Rubber

The butadiene-acrylonitrile rubber is a copolymer of butadiene with acrylonitrile. The basic differences between the types are mainly due to the concentration of acrylonitrile in the rubber and the amount of the stabilizer used.

These rubbers are commercially known as nitrile rubber, and according to their characteristics are classified in NBR, Buna N, and GRN rubbers.

### Neoprene

The neoprenes are synthetic rubbers that are obtained by polymerizing the chloroprene, which is manufactured by reacting the butadiene with chlorine and treating the reaction product with caustic potash. The neoprenes may be copolymerized with methacrylic acid using as emulsifier polyvinyl alcohol, and also the neoprenes may be copolymerized with acrylonitrile.

### Butyl Rubber

The butyl rubber is a synthetic rubber, a copolymer of isobutylene with isoprene. The abbreviation for isoprene-isobutylene rubber is IIR (Isobutylene Isoprene Rubber). The poly-isobutylene, also known as PIB or polyisobutene, (C₄H₈)n, is the isobutylene homopolymer, or 2-methyl-1-propene, in which is based the butyl rubber. The butyl rubber is produced by the polymerization of about 98% of isobutylene with 2-3% of isoprene.

### Polyisoprene

The polyisoprene cis-1,4 is the product of the polymerization of the isoprene. The natural rubber contains approximately 85% of the cis-1,4 polyisoprene, in its molecular structure, which makes this elastomer the closest to the Hevea brasillensis rubber. Therefore, it can be exchanged by the latter in most of their applications.

### Ethylene-Propylene Rubber (EPM and EPDM)

The ethylene-propylene rubbers are synthesized either in blocks or from monomers, such as the thermoplastic polymers, polypropylene and polyethylene. The ethylene and the propylene are randomly combined to produce stable and elastic polymers. A large family of ethylene-propylene elastomers may be produced reaching from non-crystalline amorphous structures to semi-crystalline structures depending on the composition of the polymer and how they are combined. These polymers are also produced in a wide range of viscosity Mooney (or molecular weights).

The ethylene and the propylene are combined to form a saturated carbon chain polymer, chemically stable generating an excellent resistance to the heat, the oxidation, the ozone, and the elements. A third non-conjugated diene monomer may be terpolymerized in a controlled manner to keep a saturated chain and an unsaturated reactive zone at one side of the main chain susceptible to vulcanization or chemical modification of the polymer. The terpolymers are referred to as EPDM (ethylene-propylene-diene with the M referring to the saturated chain structure). The ethylene-propylene copolymer is called EPM.

### Elastomers

The word elastomer refers to a polymer that has the distinction of being very elastic and may even regain its shape after being deformed. Because of these characteristics, the elastomers are the basic material for the manufacture of other materials, such as rubber, whether natural or synthetic, and to some adhesive products. More specific, an elastomer is a chemical compound formed by thousands of molecules called monomers, which are attached forming huge chains. It is thanks to these large chains that these polymers are elastic because they are flexible and interconnected in a very disorderly way.

Most of these polymers are hydrocarbons, therefore, are formed by hydrogen and carbon, and they are naturally obtained from the polyisoprene, which comes from the latex of the rubber trees. Another way to obtain an elastomer is from the petroleum synthesis and natural gas. For a more practical use of these elastomers, they should be subjected to different treatments. Through the application of sulfur atoms, this polymer is more resistant, thanks to a process called vulcanization.

The different elastomers referenced in the present invention are derivatives of the previously classified rubbers with the peculiarity that these rubbers are partially or fully cross-linked by different chemical reactions generating a vulcanization state.

### Rubber and Elastomers Recycling

The term rubber and elastomer recycling is used for the above-mentioned different polymers which have undergone one or various transformation processes, generating utility materials employees, in various productive sectors and once ending their useful life, they become waste materials that cause environmental pollution.

### Binder Form of Composite Materials

The term binder refers to a substance, formed by an in-situ polymerization system between the combination of different monomers and/or diisocyanate oligomers, esters, or cross-linking organic peroxides agents, which are used to give general support to a specific mixture based on rubbers and/or elastomers, and/or it's recycled.

This invention uses different monomers, and/or diisocyanate oligomers, and/or esters to form various functional binders for rubbers and/or elastomers, and/or it's recycled via the in situ polymerization between their combinations. The obtained binders are polyurethane, polyester, and polyurethane-polyester, with the peculiarity of improving the chemical structure and therefore the intrinsic properties such as thermal, rheological and mechanical, deriving this modification on the employment in the organic peroxides polymerization.

### Type Polyurethane Binder

The polyurethanes “include” or “contain” amounts of the reactant components (for example, diisocyanate diol and chain extender), their structural units, or simply their ‘units’, refer to the fact that the polyurethane contains the reaction product or remnants of that reactant in the polymerized form.

The two main components of the polyurethanes are a hard segment and a soft segment. The “hard segment” is the combination of the diisocyanate components and the chain extender and the “soft segment” is the balance of the polyurethane that is usually the diol component.

This type of binders are prepared by reacting diisocyanate compounds, polymeric diols, and organic peroxides. Also by using thermoplastic polyurethane ureas or “TPUU” prepared by reacting diisocyanate compounds with an amine in place of or in addition to the organic peroxides.

In U.S. Pat. No. 6,521,164 and U.S. Pat. No. 4,371,684 was suggested the preparation of polyurethanes based on these and other diols with combinations of chain extenders to improve processing and injection moldability. Historically, however, little has been explained about how to use these polyurethanes as binders replacing the use of the conventional hydroxyl type chain extenders with organic peroxides in mixtures based on rubbers and/or elastomers, and/or it's recycled. Therefore, it is desired to improve the properties of the polyurethane binder systems with rubber and/or elastomer, and/or its recycled prepared from polyester diols.

The suitable diisocyanates to be used in the preparation of the hard segment of polyurethanes include aromatic, aliphatic, and cycloaliphatic diisocyanates and combinations thereof. A structural unit derived from the diisocyanate (—OCN—RNCO—) is represented by the following formula:

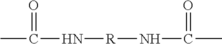

wherein R is an alkylene, cycloalkylene, or arylene group. The representative examples of these diisocyanates can be found in U.S. Pat. Nos. 4,385,133; 4,522,975 and 5,167,899. The preferable diisocyanates include 4,4′-diisocyanate diphenylmethane (“MDI”), p-phenylene diisocyanate, 1,3-bis(isocyanatomethyl)-cyclohexane, 1,4-diisocyanate-cyclohexane, hexamethylene diisocyanate, 1,5-naphthalene diisocyanate, 3,3′-dimethyl-4,4′-biphenyl diisocyanate, 4,4′-diisocyanate-dicyclohexylmethane, and 2,4-toluene diisocyanate.

The diols used in the preparation of the polyurethanes and useful in the present invention are compounds containing an average of approximately two reactive groups with isocyanate groups, usually active hydrogen, such as —OH, primary and secondary amines, and/or —SH. Representative examples of the suitable diols include polyester, poly lactone, polyether, polyolefin, diols polycarbonate, and other various diols. They are described in publications such as High Polymers, Vol. XVI; “Polyurethanes, Chemistry and Technology”, Saunders and Frisch, Interscience Publishers, New York, Vol. I, p. 32-42, 44-54 (1962), and Vol IL p. 5-6, 198-199 (1964); Organic Polymer Chemistry of K. J. Saunders, Chapman and Hall, London, p. 323-325 (1973); and Developments in Plolyurethanes, Vol. I, J. M. Burst, ed., Applied Science Publishers, p. 1-76 (1978).

The suitable polyester diols include the groups of diols mentioned such as polyester, aliphatic polyester diols, poly caprolactone diols, and aromatic polyester diols. The polyester diols suitable for use in the polyurethane of the present invention are available on the market and may be prepared by specific combinations of properties and costs by known techniques.

It is to be understand that the chain extender polyesters made from a glycol, (e.g. ethylene and/or propylene glycol) may or may not be included and a saturated dicarboxylic acid (for example, adipic acid, as well as polycaprolactone diols). By way of a non-limiting example can be mentioned poly(adipate ethylene) glycol, poly(adipato propilene) glycol, poly(adipate butilene) glycol, poly(sebacate neopentyl) glycol, etc.

The suitable polyester diols include those that can be obtained by reacting diols such as 1,4-butanediol, hydroquinone bis(2-hidroxyethyl) ether, ethylene glycol, diethylene glycol, triethylene glycol, propylene glycol, dipropylene glycol, 2-methyl-2-ethyl-1,3-propanodiol, 2-etil-1,3-hexanediol, 1,5-pentanediol, thiodiglycol, 1,3-propanediol, 1,1,3-butanediol, 2,3-Butanediol, 1, neopentylalcohol glycol, 2-dimethyl-1, 2-ciclopentanodiol, 1,6-hexanediol, 1,1,2-cyclohexenodiol, 2-dimethyl-1,2-cyclohexanediol, glycerol, trimethylol propane, trimethylol ethane, 1,2,4-butanediol, 1,2,6, pentaerythritol, dipentaerythritol, tripentaeritritol, anhidroanheptitol, mannitol, sorbitol, methyl-glucoside, and similar with dicarboxylic acids such as adipic acid, succinic acid, glutaric acid, azelaic acid, sebacic acid, malonic acid, maleic acid, fumaric acid, phthalic acid, isophthalic acid, terephthalic acid, tretracloroftalico acid, and chlorendic acid; in addition, the acid anhydrides, alkyl esters, and these halides acids of these acids can be used.

The diol or diols used in the polyurethanes, as the component of the soft segment occasionally may contain minority amounts, preferably less than approximately 10 mole %, more preferably less than approximately 5 mole % of a reactant of superior functionality, such as a triol, as an impurity or for the purposes of modifying the properties, such as a change in the flow or processability. However, for the preferred polyurethanes according to the present invention, there is not added a polyol of superior functionality nor is contained in the soft segment diol.

The hard segment of the polyurethane of the present invention may or may not contain structural units of at least one chain extender. The global amount of the chain extender component is incorporated in the polyurethane in determined quantities by the selection of specific reagents and components, the desired quantities of the hard and soft segments enough to provide good mechanical properties.

### Types of Chain Extenders

a) 1,4-Butanediol (“Butanediol” or “BDO”). A structural unit of the BDO chain extender is represented by the following formula:

HO—CH2CH2CH2CH2-OH

The butanediol chain extender may or may not be incorporated in the polyurethane in sufficient quantities to provide good mechanical properties, such as module and tear resistance. This is generally at levels of at least approximately 30-80% of equivalent (% eq.) based on the total equivalent of the NCO/OH ratio.

b) a linear chain extender different from 1,4-butanediol. The suitable linear chain extenders include ethylene glycol and diethylene glycol; ethylene glycol and 1,3-propane diol; 1 6-hexanediol; 1,5-heptanodiol; or diethylene glycol or triethylene glycol and 1,3-propanediol, or a combination thereof. These chain extenders are usually diol, diamine, or amino alcohol compounds characterized by having a molecular weight of no more than 500 Dalton. In this context, linear refers to a chain extender compound that is not cyclical and does not have an alkyl chain branch from a tertiary carbon. A structural unit of the linear chain extension is represented by the following formula:

HO—(CH₂)n-OH or H₂N—(CH₂)n-NH₂H₂N—(CH₂)ₙ—OH

c) the cyclic chain extenders include cyclohexane dimethanol (“CHDM”), and hydroquinone bis-2-hydroxyethyl ether (HQEE).

In the present invention, in order to obtain better properties in different materials, three organic peroxides are included, dicumyl peroxide (DCP), lauryl peroxide (PL), and benzoyl peroxide (PBO) replacing the described chain extenders and in combination with them.

The new composite materials based on rubber, elastomers, and its recycled together with the different binders according to the present invention may be manufactured by using the processes commonly used to prepare these types of polymer such as reactive mixing, reactive injection molding and molding by compression, pressing, injection molding by reactive extrusion and injection.

The TPU or the TPUU of the present invention is useful, for example, in outside parts of footwear and other applications where transparency is important such as in an overlay, a film, a sealer, as well as in various articles including culled articles, injection molded articles, and extruded articles such as shoe soles, hose covers, tubes, wheels, and a barrier layer for hospital gowns.

Development of New Composite Materials Based on Rubber, Elastomers, and it's Recycled.

The following examples are for illustrative purposes only and are not intended to limit the scope of this invention. In this and the following tables and experiments, the amounts of the reagents components displayed are shown in weight or percentage of equivalent of the reactants used to prepare the material and that as a result the same amount of the reactant or structural unit in the polymer.

### Examples

The indicated levels of raw materials were provided from tanks using tubes, pumps, and flow meters for control flow and provide the appropriate proportions to the feeding tube of an intensive mixer.

The components used for the synthesis were the following:

The diisocyanate is MDI, 4,4′-diisocyanate diphenylmethane, such as POLIUR AMR871 MDI (a trade name of AMERIPOL CHEMICAL).

The diol used in experiments is a polycaprolactone diol available on the market by The Dow Chemical Company prepared by the reaction of e-caprolactone using 1,4-butanediol as the initiator and with a molecular weight of 1500.

The BDO is 1,4-butanediol obtained by BASF Corporation.

The catalyst is stannous octoate obtained as Dabco T-9 by Air Products & Chemical, Inc, and was used to an amount of 0.02 percent.

The stabilizer package is the antioxidant IRGANOX 1010 (a commercial trademark of Ciba-Geigy) used to an amount of 0.2 percent based on the weight of TPU. The ADVAWAX 280 wax was used in an amount of 0.25% based on the weight of the TPU.

The Diana index (equivalent ratio: diisocyanate equivalent to the total equivalent of diol and the chain extender) was 1.03:1.

All materials were prepared on the basis of a recycling elastomer from waste tires, which was shredded and sifted through a number 8 mesh which particle size is 2.38 mm. 2000 g of the recycling tire elastomer was used as 100% of the mixture. Also, all of the binders were prepared, at 10% of the recycled elastomer, from a diol, a diisocyanate, and a chain extender, the latter can be replaced by an organic peroxide or by an equivalent combination between both components.

For the production of each of the binders, the calculation was made for the corresponding quantities in equivalent, starting with 200 grams of the diol (corresponding to 10% of recycled elastomer) and determining the amount of isocyanate required for achieving the desired NCO/OH ratio=2. Subsequently, considering the free NCO equivalents in the prepolymer, the amount required of the chain extender was added so that in the final polyurethane does not include free NCO. Table 1 includes amounts in grams of reagents used and the percentage of free NCO free in the prepolymer.

TABLE 1
quantities in grams of reagents used in the formation of the binder

| | | | | | % | | |
|---|---|---|---|---|---|---|---|
| Sam- | | NCO/ | | Isocy- | NCO | Chain | Organic |
| ple | Binder | OH | Diol | anate | free | Extender | Peroxide |
| 1 | MDI | 2 | 200 | 35.7 | 2.6 | 10.4 | |
| 2 | MDI | 2 | 200 | 35.7 | 2.6 | 6.4 | |
| 3 | MDI | 2 | 200 | 35.7 | 2.6 | 2.4 | |
| 4 | Polyester | 2 | 200 | | | 10.4 | |
| 5 | MDI | 2 | 200 | 35.7 | 2.6 | | 10.4 |
| 6 | MDI | 2 | 200 | 35.7 | 2.6 | | 6.4 |
| 7 | MDI | 2 | 200 | 35.7 | 2.6 | | 2.4 |
| 8 | Polyester | 2 | 200 | | | | 10.4 |
| 9 | MDI | 2 | 200 | 35.7 | 2.6 | 5.2 | 5.2 |
| 10 | MDI | 2 | 200 | 35.7 | 2.6 | 3.2 | 3.2 |
| 11 | MDI | 2 | 200 | 35.7 | 2.6 | 1.2 | 1.2 |
| 12 | Polyester | 2 | 200 | | | 5.2 | 5.2 |

The samples presented in Table 1 were first mixed in an intensive mixer at room temperature of 25° C. and then they were poured into a mold with approximate dimensions of 17×17 cm. After, the mold was placed in a hydraulic press, Carver model 4122, of 10 metric tons which applies a constant force of 3 ton for 10 min at 80° C. Finally the mold cooled with water, maintaining the pressure for 10 min.

The results are shown in Table 2.

TABLE 2
Chilling time and elastic module during the
process of the generation of the binder.

| | | | \| η *\| | | | |
|---|---|---|---|---|---|---|
| | Chilling | G′ | final | % free | Chain | Organic |
| Sample | Time (s) | (Pa) | (Pa s) | NCO | Extender | Peroxide |
| 1 | 714 | 215600 | 334500 | 2.6 | 10.4 | |
| 2 | 1186 | 26530 | 91670 | 2.6 | 6.4 | |
| 3 | 4286 | 109 | 13090 | 2.6 | 2.4 | |
| 4 | 1495 | 826100 | 135800 | | 10.4 | |
| 5 | 310 | 324220 | 456780 | 2.6 | | 10.4 |
| 6 | 725 | 47345 | 128654 | 2.6 | | 6.4 |
| 7 | 2323 | 325 | 26790 | 2.6 | | 2.4 |
| 8 | 935 | 957123 | 156892 | | | 10.4 |
| 9 | 689 | 238972 | 367987 | 2.6 | 5.2 | 5.2 |
| 10 | 859 | 35789 | 105432 | 2.6 | 3.2 | 3.2 |
| 11 | 3689 | 225 | 17654 | 2.6 | 1.2 | 1.2 |
| 12 | 1320 | 935762 | 156765 | | 5.2 | 5.2 |

Table 2 shows the results obtained from the time sweep analysis. As can be seen in the polyurethane samples, as the number of chain extenders increase AM33, the chilling time decreases and the rigidity (G′) of the material increases.

In the case of sample 4 corresponding to the polyester-1%, the time sweep was conducted at 55 minutes, instead of 3 hours. When analyzing the elastic module at the 3300 s (55 min), the sample 4 Poliester-1% presented the greater rigidity (higher G′) even if the chilling time was greater than the samples 1, 2 and 3. This shows the changes in properties of the different materials to be made based on reagents involving structure types of polyesters and polyurethanes.

In table 2, can be observed the effect of adding the organic peroxide in the formation of the materials; materials were obtained with lower chilling time and greater rigidity as the amount of peroxide was increased in the mix. This effect is also observed still and being in proportion to the chain extenders.

It is also possible in the present invention the development of new composite materials based on rubber, elastomers, and it's recycled using a mixture of two types of binders, polyurethane and polyester, at 10% by weight taking as 100% the content of recycled elastomer. The binder formulations used were the following:

| | Polyurethane POLIUR AMR | |
|---|---|---|
| | 871 + chain Extender AM33 | Polyester + catalyst |
| Formulation | 1% by weight | 1% by weight |
| Mix 1 | 90% by weight | 10% by weight |
| Mix 2 | 70% by weight | 30% by weight |
| Mix 3 | 50% by weight | 50% by weight |
| Mix 4 | 30% by weight | 70% by weight |
| Mix 5 | 10% by weight | 90% by weight |

### Rheological Analysis of Mixtures of the Binder Poliuretano-Poliester

### Rotational Rheometry: Time Sweeping

The values obtained from the analysis of the time sweeping are listed in Table 3.

As it can be seen, the blend of 90% polyurethane-10% polyester showed a decrease in the chilling time and a higher value of the elastic module with regard to the polyurethane (100% polyurethane), so adding 10% polyester to the polyurethane increased the rigidity and decreased the curing time of the material. Values shown by the blend of 90% polyurethane-10% polyester are among the values of 100% polyurethane and 100% polyester.

When evaluating the mixtures of 70% polyurethane-30% polyester and 50% polyurethane-50% polyester, they showed lower values of the elastic module (G′) than 100% polyurethane and 100% polyester. In addition, the chilling time did not occur during the testing time, which indicates a decrease in the speed of cross-linking.

The mixture 30% polyurethane-70% Polyester begins with values of G′ below those recorded for the sample of 100% polyurethane, but exceeds it from the 2880 s. Despite this, the chilling time did not occur during the testing time, which indicates a decrease in the speed of cross-linking.

Finally, when mixing 10% polyester-90% polyurethane the lower chilling time occurred in the evaluated mixtures which gives a greater cross-linking speed and a higher value of the elastic modulus (G′).

TABLE 3
Chilling time and elastic module during the process
of formation of the polyurethane-polyester Binder

| | Chilling | G′ @ 2200 s | G′ @ 3300 s | G′ @ 4800 s |
|---|---|---|---|---|
| Sample | Time (s) | (Pa) | (Pa) | (Pa) |
| 100% PU | 4286 | 53.8 | 109.6 | 673.3 |
| 90%-10% PU | 3650 | 248.5 | 1259 | 9654 |
| polyester | | | | |
| 70%-30% PU | — | 28.36 | 40.49 | 58.12 |
| polyester | | | | |
| 50%-50% PU | — | 11.87 | 28.57 | 81.81 |
| polyester | | | | |
| 30%-70% PU | — | 29.20 | 176.4 | 1027 |
| polyester | | | | |
| 10%-90% PU | 1415 | 308900 | — | — |
| polyester | | | | |
| 100% polyester | 1495 | 105600 | 826100 | — |

To evaluate the role of the polyurethane chain extenders: AM33 and the polyester: K2000, the following mixtures were made to be compared with the mixture of 50% Polyurethane+AM33-50% Polyesther+K2000:

50% polyurethane-50% polyester+AM33

50% polyurethane-50% polyester+K2000

50% polyurethane-50% polyester+benzoyl peroxide (PBO)

50% polyurethane-50% polyester+AM33+PBO

The obtained values for the elastic module are listed in Table 4. As can be seen, were obtained, with variations in the chain extenders or with only one of them present in the mix, an endless range of new materials with specific properties based on the modification of chilling times for each material. The addition of benzoyl peroxide as a substitute for the chain extenders shows varied chilling times resulting in materials with a degree of rigidity to those obtained in previous trials. The chilling time was not recorded during the test time for all evaluated mixtures.

TABLE 4
Chilling Time and elastic module during the curing process

| | Chilling | G′ @ 2200 s | G′ @ 3300 s | G′ @ 4800 s |
|---|---|---|---|---|
| Sample | Time (s) | (Pa) | (Pa) | (Pa) |
| 50% PU − | — | 11.87 | 28.57 | 81.81 |
| 50% polyester + | | | | |
| AM33 + K200 | | | | |
| 50% PU − | — | 12.93 | 2130 | 27.66 |
| 50% polyester + | | | | |
| AM33 | | | | |
| 50% PU − | — | 1.40 | 6.06 | 19.57 |
| 50% polyester + | | | | |
| K2000 | | | | |
| 50% PU − | — | 3.95 | 10.67 | 27.80 |
| 50% polyester + | | | | |
| PBO | | | | |
| 50% PU − | — | 7.32 | 14.13 | 35.79 |
| 50% polyester + | | | | |
| AM33 + PBO | | | | |

These results demonstrate that it is possible to develop and obtain new composite materials based on rubber, elastomers, and it's recycled. With properties specifically based, using different concentrations of chain extenders, peroxides, and binders.

1-5. (canceled)

6. A composition to produce a polymer-binder composite material comprising:
a) a first polymer matrix containing at least one elastomer polymer selected from rubbers including the group consisting of polybutadienes; butadiene-styrene rubbers; butadiene-acrylonitrile rubbers; butyl rubbers; polyisobutylenes, polyisoprenes;
ethylene-propylene rubbers; the at least one elastomer having a particle size of between 9.51 mm to 0.075 mm;
b) a second polymeric matrix containing at least one elastomeric polymer selected from the rubber derivate elastomers of a), the at least one rubber derivate elastomers is partially or totally cross-linked and has a particle size of between 9.51 mm to 0.075 mm;
c) a third polymeric matrix containing at least one recycled rubber elastomeric polymer and elastomers, the at least one recycled rubber is partially or totally cross-linked and in a vulcanization state; the at least one recycled rubber has a particle size of between 9.51 to 0.075 mm.

7. The composition according to claim 6, wherein the first polymeric matrices and the second polymeric matrix are of a pure origin or a recycled origin.

8. The composition according to claim 6, further including:
d) a first composition to produce a polymer-binder composite material with the addition of polyurethane binder in an amount of from 3 to 80% in weight, based on a total weight of the polymeric matrix, where the polyurethane binder includes a soft segment in a quantity of 10 to 90% and a hard segment in a quantity of 10 to 90% by weight, based on a total weight of the polyurethane; the hard segment includes a diisocyanate and at least one of a chain extender and organic peroxides, the chain extender comprise butanediol in an amount of 5 to 96% based on the amount of the polymeric matrix and the organic peroxides are in an amount equivalent in weight to the chain extender;
e) a second composition to produce a polymer-binder composite material with the addition of polyurethane binder including a soft segment in an amount of 10 to 90% by weight and a hard segment in a quantity of 10 to 90% by weight based on the total weight of the polyurethane; the hard segment comprises diisocyanate and organic peroxides in an amount of 0.5 to 10% by weight to the total weight of the polyurethane.

9. The composition according to claim 6, further including:
f) a first composition to produce a polymer-binder composite material with the addition of polyester binder in an amount from 3 to 80% by weight based on the total weight of the polymeric matrix, where the first polyester binder contains a homogeneous mixture of a polymeric central chain which is dissolved in a styrene monomer; the chain is formed by glycols having in two hydroxyl groups (OH) selected from the group consisting of ethylene glycol, propylene glycol, and neophentyl glycol; saturated acids, molecules having carboxyl groups (COOH) including orthophthalic anhydride and isophthalic acid; unsaturated acids, molecules including unsaturations with double bonds between carbon and carbon (C═C) including maleic anhydride; and fumaric acid;
g) a second composition to produce a polymer-binder composite material with the addition of polyester binder in an amount of 3 to 80% by weight based on the total weight of the polymeric matrix, where the second polyester binder is formed by a homogeneous mixture of a polymeric central chain mixed with the organic peroxide in a quantity of 1 to 10% by weight of the total weight of the second polyester binder and the chain is formed by different glycols having two groups hydroxyl (OH) including ethylene glycol, propylene glycol, and neophentyl; saturated acids, molecules having carboxyl groups (COOH) including orthophthalic anhydride and isophthalic acid; unsaturated acids, including insaturaciones with double bonds between carbon and carbon (C═C) including maleic anhydride; or fumaric acid.

10. The composition according to claim 6, wherein the polyurethanes and the polyester binders mixtures includes 5 to 95% by weight of the polyurethane binder based on the weight of the polymeric matrix total and 5 to 95% by weight of the polyester binder based on the weight of the total polymer matrix.
